(19) United States
(12) Patent Application Publication
(10) Pub. No.: US 2011/0149331 A1
(43) Pub. Date: Jun. 23, 2011

(54) DYNAMIC PRINTER MODELLING FOR OUTPUT CHECKING

(75) Inventors: Matthew Christian Duggan, Tokyo-to (JP); Eric Wai-Shing Chong, Carlingford (AU); Stephen James Hardy, West Pymble (AU)

(73) Assignee: CANON KABUSHIKI KAISHA, Tokyo (JP)

(21) Appl. No.: 12/955,404

(22) Filed: Nov. 29, 2010

(30) Foreign Application Priority Data
Dec. 23, 2009 (AU) 2009251147

(51) Int. Cl. G06K 15/02; G06K 9/00

(52) U.S. Cl. 358/1.14; 382/112

(57) ABSTRACT

Disclosed is a method (100) for detecting print errors, the method comprising printing (130) a source input document (166) to form an output print (163), imaging (140) the output print (163) to form a scan image (164), determining a set of parameters modelling characteristics of the printer used to perform the printing step, determining values for the set of parameters dependent upon operating condition data for the printer, rendering (120) the source document (166), dependent upon the parameter values, to form an expected digital representation (227), and comparing (270) the expected digital representation to the scan image to detect the print errors

### REFERENCE TO RELATED PATENT APPLICATION(S)

This application claims the benefit under 35 U.S.C. §119 of the filing date of Australian Patent Application No 2009251147, filed 23 Dec. 2009, hereby incorporated by reference in its entirety as if fully set forth herein.

### TECHNICAL FIELD OF INVENTION

The current invention relates generally to the assessment of the quality of printed documents, and particularly, to a system for detection of print defects on the printed medium.

### BACKGROUND

There is a general need for measuring the output quality of a printing system. The results from such quality measurement may be used to fine-tune and configure the printing system parameters for improved performance. Traditionally, this has been performed in an offline fashion through manual inspection of the output print from the print system.

With ever increasing printing speeds and volume, the need for automatic real-time detection of print defects to maintain print quality has increased. Timely identification of print defects can allow virtually immediate corrective action such as re-printing to be taken, which in turn reduces waste in paper and ink or toner, while improving efficiency.

A number of automatic print defect detection systems have been developed. In some arrangements, these involve the use of an image acquisition device such as a CCD (charge-coupled device) camera to capture a scan image of a document printout (also referred to as an output print), the scan image then being compared to an image (referred to as the original image) of the original source input document. Discrepancies identified during the comparison can be flagged as print defects.

### SUMMARY

It is an object of the present invention to substantially overcome, or at least ameliorate, one or more disadvantages of existing arrangements.

Disclosed are arrangements, referred to as Adaptive Print Verification (APV) arrangements, which dynamically adapt a mathematical model of the print mechanism to the relevant group of operating conditions in which the print mechanism operates, in order to determine an expected output print, which can then be compared to the actual output print to thereby detect print errors.

According to a first aspect of the present invention, there is provided a method for detecting print errors by printing an input source document to form an output print, which is then digitised to form a scan image. A set of parameters modelling characteristics of the print mechanism is determined, these being dependent upon operating conditions of the print mechanism. The actual operating condition data for the print mechanism is then determined, enabling values for the parameters to be calculated. The source document is rendered, taking into account the parameter values, to form an expected digital representation, which is then compared with the scan image to detect the print errors.

According to another aspect of the present invention, there is provided an apparatus for implementing the aforementioned method.

According to another aspect of the present invention, there is provided a computer readable medium having recorded thereon a computer program for implementing the method described above.

Other aspects of the invention are also disclosed.

### BRIEF DESCRIPTION OF THE DRAWINGS

One or more embodiments of the invention will now be described with reference to the following drawings, in which:

FIG. 1 is a top-level flow-chart showing the flow of determining if a page contains unexpected differences;

FIG. 2 is a flow-chart showing the details of step 150 of FIG. 1;

FIG. 3 is a diagrammatic overview of the important components of a print system 300 on which the method of FIG. 1 may be practiced;

FIG. 4 is a flow-chart showing the details of step 240 of FIG. 2;

FIG. 5 is a flow-chart showing the details of step 270 of FIG. 2;

FIG. 6 is a flow-chart showing the details of step 520 of FIG. 5;

FIG. 7 shows a graphical view of how the steps of FIG. 2 can be performed in parallel.

FIG. 8 is a flow-chart showing the details of step 225 of FIG. 2;

FIG. 9 illustrates a typical dot-gain curve 910 of an electrophotographic system;

FIG. 10 is a kernel which can be used in the dot-gain model step 810 of FIG. 8;

FIG. 11 shows the detail of two strips which could be used as input to the alignment step 240 of FIG. 2;

FIG. 12 shows the process of FIG. 8 as modified in an alternate embodiment;

FIG. 13 shows the process of FIG. 6 as modified in an alternate embodiment;

FIGS. 20A and 20B collectively form a schematic block diagram representation of an electronic device upon which described arrangements can be practised; and

FIG. 21 shows the details of the print defect detection system 330 of FIG. 3.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

It is to be noted that the discussions contained in the “Background” section and that above relating to prior art arrangements relate to discussions of devices which may form public knowledge through their use. Such discussions should not be interpreted as a representation by the present inventor(s) or the patent applicant that such devices in any way form part of the common general knowledge in the art.

An output print 163 of a print process 130 will not, in general, precisely reflect the associated source input document 166. This is because the print process 130, through which the source input document 166 is processed to produce the output print 163, introduces some changes to the source input document 166 by virtue of the physical characteristics of a print engine 329 which performs the print process 130. Furthermore, if the source input document 166 is compared with a scan image 164 of the output print 163, the physical characteristics of the scan process 140 also contribute changes to the source input document 166. These (cumulative) changes are referred to as expected differences from the source input document 166 because these differences can be attributed to the physical characteristics of the various processes through which the source input document 166 passes in producing the output print 163. However, there may also be further differences between, for example, the scan image 164 and the source input document 166, which are not accounted for by consideration of the physical characteristics of the print engine 329 performing the printing process 130, and the scanner process 140. Such further differences are referred to as unexpected differences, and these are amenable to corrective action. The unexpected differences are also referred to as “print defects”.

The disclosed Adaptive Print Verification (APV) arrangements discriminate between expected and unexpected differences by dynamically adapting to the operating condition of the print system. By generating an “expected print result” in accordance with the operating conditions, it is possible to check that the output meets expectations with a reduced danger of falsely detecting an otherwise expected change as a defect (known as “false positives”).

In one APV arrangement, the output print 163 produced by a print process 130 of the print system from a source document 166 is scanned to produce a digital representation 164 (hereinafter referred to as a scan image) of the output print 163. In order to detect print errors in the output print 163, a set of parameters which model characteristics of the print mechanism of the print system are firstly determined, and values for these parameters are determined based on operating condition data for at least a part of the print system. This operating condition data may be determined from the print system itself or from other sources, such as for example, external sensors adapted to measure environmental parameters such as the humidity and/or the temperature in which the print system is located. The value associated with each of the parameters is used to generate, by modifying a render 160 of the source document 166, an expected digital representation of the output print 163. The expected digital representation takes into account the physical characteristics of the print system, thereby effectively compensating for output errors associated with operating conditions of the print system (these output errors being expected differences). The generated expected digital representation is then compared to the scan image 164 of the output print 163 in order to detect unexpected differences (ie differences not attributable to the physical characteristics of the print system) these being identified as print errors in the output of the print system.

In another APV arrangement, the operating condition data is used to determine a comparison threshold value, and the generated expected digital representation is compared to the scan image 164 of the output print 163 in accordance with this comparison threshold value to detect the unexpected differences (ie the print errors) in the output of the print system by compensating for output errors associated with operating conditions of the print system.

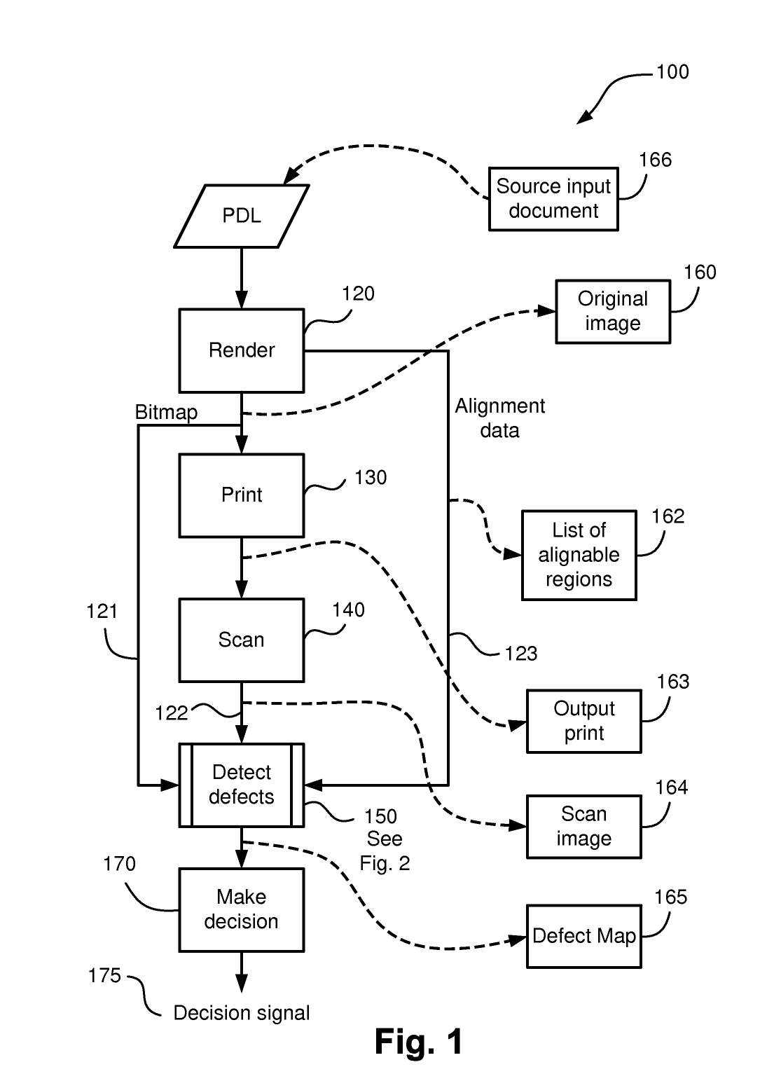

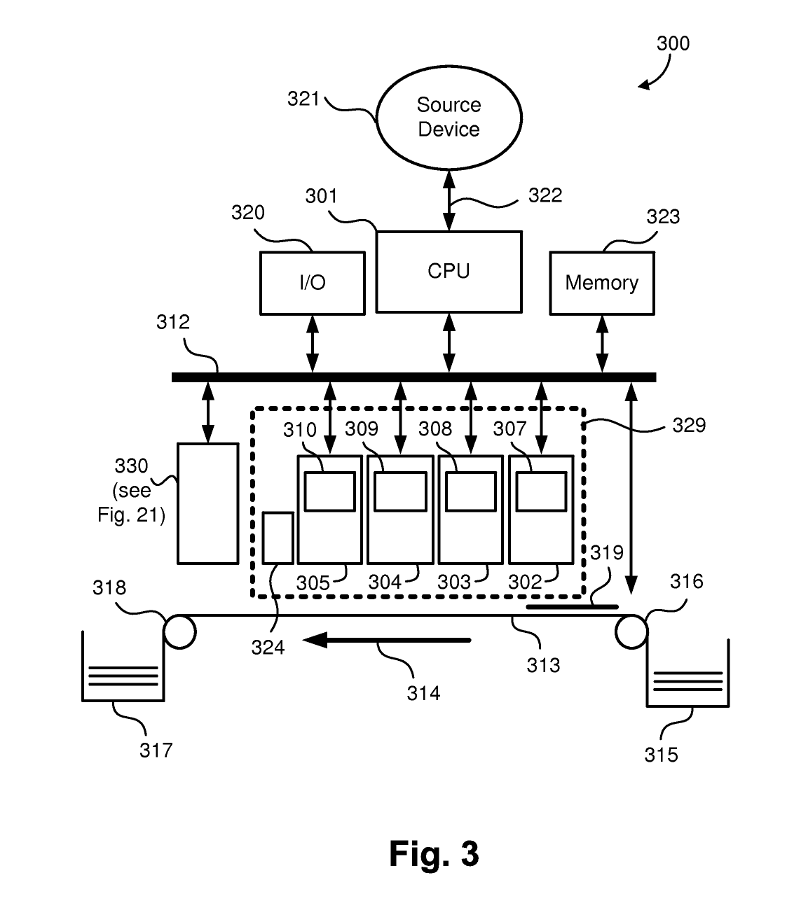

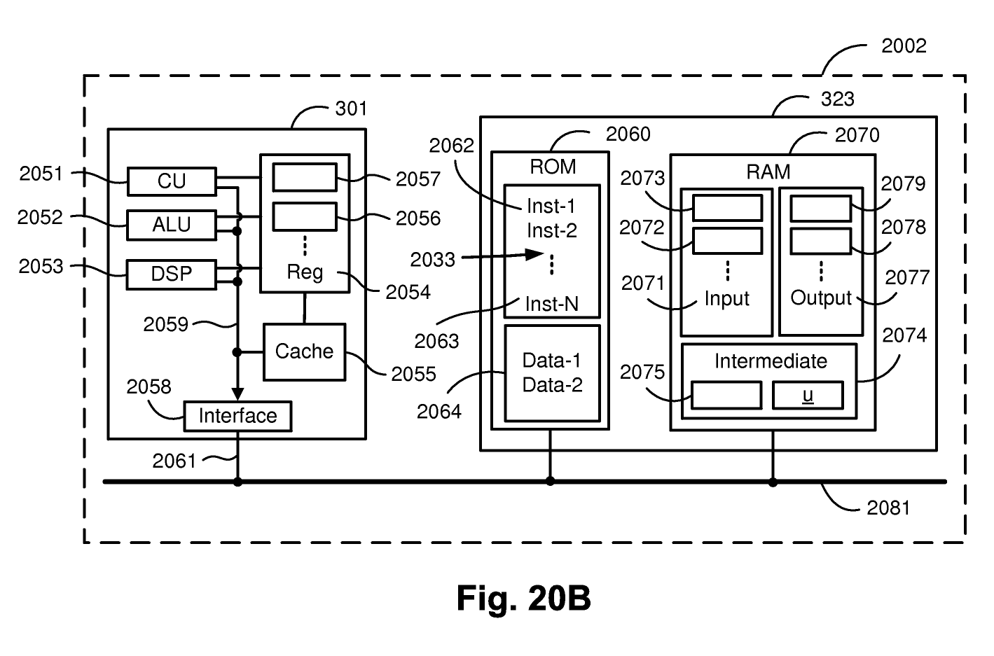

FIG. 3 is a diagrammatic overview of the important components of a print system 300 on which the method of FIG. 1 may be practiced. An expanded depiction is shown in FIGS. 20a and 20B. In particular, FIG. 3 is a schematic block diagram of a printer 300 with which the APV arrangements can be practiced. The printer 300 comprises a central processing unit 301 connected to four chromatic image forming units 302, 303, 304, and 305. For ease of description, chromatic colourant substances are each referred to simply as the respective colour space—“colourant”. In the example depicted in FIG. 3, an image forming unit 302 dispenses cyan colourant from a reservoir 307, an image forming unit 303 dispenses magenta colourant from a reservoir 308, an image forming unit 304 dispenses yellow colourant from a reservoir 309, and an image forming unit 305 dispenses black colourant from a reservoir 310. In this example, there are four chromatic image forming units, creating images with cyan, magenta, yellow, and black (known as a CMYK printing system). Printers with less or more chromatic image forming units and different types of colourants are also available.

The central processing unit 301 communicates with the four image forming units 302-305 by a data bus 312. Using the data bus 312, the central processing unit 301 can receive data from, and issue instructions to, (a) the image forming units 302-305, as well as (b) an input paper feed mechanism 316, (c) an output visual display and input controls 320, and (d) a memory 323 used to store information needed by the printer 300 during its operation. The central processing unit 301 also has a link or interface 322 to a device 321 that acts as a source of data to print. The data source 321 may, for example, be a personal computer, the Internet, a Local Area Network (LAN), or a scanner, etc., from which the central processing unit 301 receives electronic information to be printed, this electronic information being the source document 166 in FIG. 1. The data to be printed may be stored in the memory 323. Alternatively, the data source 321 to be printed may be directly connected to the data bus 312.

When the central processing unit 301 receives data to be printed, instructions are sent to an input paper feed mechanism 316. The input paper feed mechanism 316 takes a sheet of paper 319 from an input paper tray 315, and places the sheet of paper 319 on a transfer belt 313. The transfer belt 313 moves in the direction of an arrow 314 (from right to left horizontally in FIG. 3), to cause the sheet of paper 319 to sequentially pass by each of the image forming units 302-305. As the sheet of paper 319 passes under each image forming unit 302, 303, 304, 305, the central processing unit 301 causes the image forming unit 302, 303, 304, or 305 to write an image to the sheet of paper 319 using the particular colourant of the image forming unit in question. After the sheet of paper 319 passes under all the image forming units 302-305, a full colour image will have been placed on the sheet of paper 319.

For the case of a fused toner printer, the sheet of paper 319 then passes by a fuser unit 324 that affixes the colourants to the sheet of the paper 319. The image forming units and the fusing unit are collectively known as a print engine 329. The output print 163 of the print engine 329 can then be checked by a print verification unit 330 (also referred to as a print defect detector system). The sheet of paper 319 is then passed to a paper output tray 317 by an output paper feed mechanism 318.

The printer architecture in FIG. 3 is for illustrative purposes only. Many different printer architectures can be adapted for use by the APV arrangements. In one example, the APV arrangements can take the action of sending instructions to the printer 300 to reproduce the output print if one or more errors are detected.

FIGS. 20A and 20B collectively form a schematic block diagram representation of the print system 300 in more detail, in which the print system is referred to by the reference numeral 2001. FIGS. 20A and 20B collectively form a schematic block diagram of a print system 2001 including embedded components, upon which the APV methods to be described are desirably practiced. The print system 2001 in the present APV example to is a printer in which processing resources are limited. Nevertheless, one or more of the APV functional processes may alternately be performed on higher-level devices such as desktop computers, server computers, and other such devices with significantly larger processing resources, which are connected to the printer.

As seen in FIG. 20A, the print system 2001 comprises an embedded controller 2002. Accordingly, the print system 2001 may be referred to as an “embedded device.”In the present example, the controller 2002 has the processing unit (or processor) 301 which is bi-directionally coupled to the internal storage module 323 (see FIG. 3). The storage module 323 may be formed from non-volatile semiconductor read only memory (ROM) 2060 and semiconductor random access memory (RAM) 2070, as seen in FIG. 20B. The RAM 2070 may be volatile, non-volatile or a combination of volatile and non-volatile memory.

The print system 2001 includes a display controller 2007 (which is an expanded depiction of the output visual display and input controls 320), which is connected to a video display 2014, such as a liquid crystal display (LCD) panel or the like. The display controller 2007 is configured for displaying graphical images on the video display 2014 in accordance with instructions received from the embedded controller 2002, to which the display controller 2007 is connected.

The print system 2001 also includes user input devices 2013 (which is an expanded depiction of the output visual display and input controls 320) which are typically formed by keys, a keypad or like controls. In some implementations, the user input devices 2013 may include a touch sensitive panel physically associated with the display 2014 to collectively form a touch-screen. Such a touch-screen may thus operate as one form of graphical user interface (GUI) as opposed to a prompt or menu driven GUI typically used with keypad-display combinations. Other forms of user input devices may also be used, such as a microphone (not illustrated) for voice commands or a joystick/thumb wheel (not illustrated) for ease of navigation about menus.

As seen in FIG. 20A, the print system 2001 also comprises a portable memory interface 2006, which is coupled to the processor 301 via a connection 2019. The portable memory interface 2006 allows a complementary portable memory device 2025 to be coupled to the print system 2001 to act as a source or destination of data or to supplement an internal storage module 323. Examples of such interfaces permit coupling with portable memory devices such as Universal Serial Bus (USB) memory devices, Secure Digital (SD) cards, Personal Computer Memory Card International Association (PCMIA) cards, optical disks and magnetic disks.

The print system 2001 also has a communications interface 2008 to permit coupling of the print system 2001 to a computer or communications network 2020 via a connection 2021. The connection 2021 may be wired or wireless. For example, the connection 2021 may be radio frequency or optical. An example of a wired connection includes Ethernet. Further, an example of wireless connection includes Bluetooth™ type local interconnection, Wi-Fi (including protocols based on the standards of the IEEE 802.11 family), Infrared Data Association (IrDa) and the like. The source device 321 may, as in the present example, be connected to the processor 301 via the network 2020.

The print system 2001 is configured to perform some or all of the APV sub-processes in the process 100 in FIG. 1. The embedded controller 2002, in conjunction with the print engine 329 and the print verification unit 330 which are depicted by a special function 2010, is provided to perform that process 100. The special function components 2010 is connected to the embedded controller 2002.

The APV methods described hereinafter may be implemented using the embedded controller 2002, where the processes of FIGS. 1-2, 4-6, 8 and 12-13 may be implemented as one or more APV software application programs 2033 executable within the embedded controller 2002.

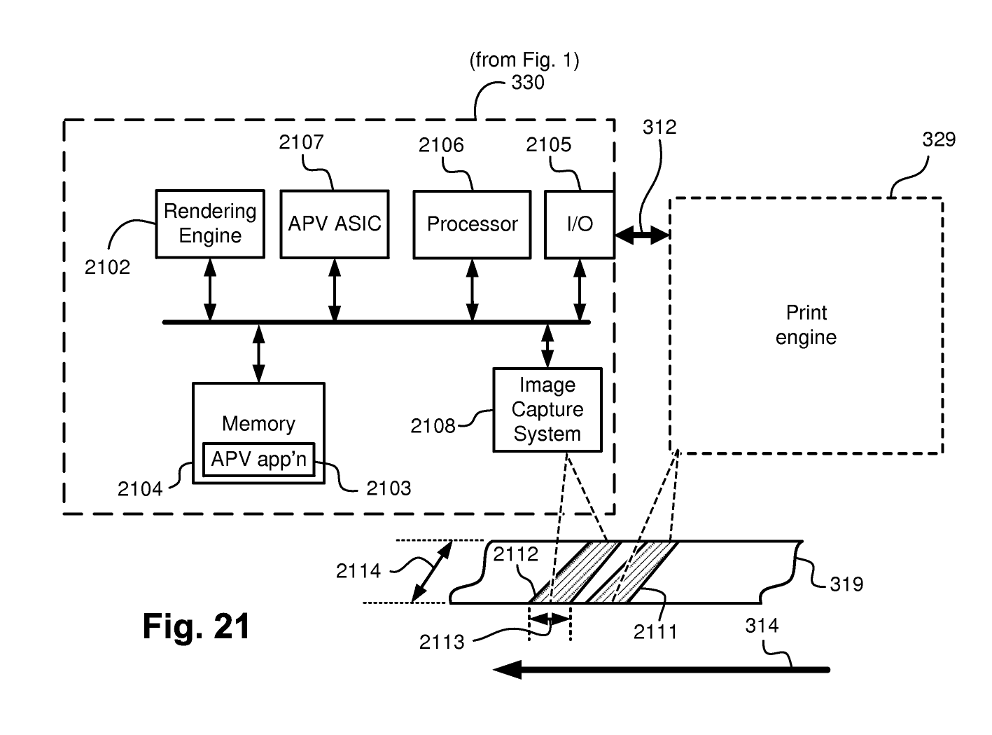

The APV software application programs 2033 may be functionally distributed among the functional elements in the print system 2001, as shown in the example in FIG. 21 where at least some of the APV software application program is depicted by a reference numeral 2103.

The print system 2001 of FIG. 20A implements the described APV methods. In particular, with reference to FIG. 20B, the steps of the described APV methods are effected by instructions in the software 2033 that are carried out within the controller 2002. The software instructions may be formed as one or more code modules, each for performing one or more particular tasks. The software may also be divided into two separate parts, in which a first part and the corresponding code modules performs the described APV methods and a second part and the corresponding code modules manage a user interface between the first part and the user.

The software 2033 of the embedded controller 2002 is typically stored in the non-volatile ROM 2060 of the internal storage module 323. The software 2033 stored in the ROM 2060 can be updated when required from a computer readable medium. The software 2033 can be loaded into and executed by the processor 301. In some instances, the processor 301 may execute software instructions that are located in RAM 2070. Software instructions may be loaded into the RAM 2070 by the processor 301 initiating a copy of one or more code modules from ROM 2060 into RAM 2070. Alternatively, the software instructions of one or more code modules may be pre-installed in a non-volatile region of RAM 2070 by a manufacturer. After one or more code modules have been located in RAM 2070, the processor 301 may execute software instructions of the one or more code modules.

The APV application program 2033 is typically pre-installed and stored in the ROM 2060 by a manufacturer, prior to distribution of the print system 2001. However, in some instances, the application programs 2033 may be supplied to the user encoded on one or more CD-ROM (not shown) and read via the portable memory interface 2006 of FIG. 20A prior to storage in the internal storage module 323 or in the portable memory 2025. In another alternative, the software application program 2033 may be read by the processor 301 from the network 2020, or loaded into the controller 2002 or the portable storage medium 2025 from other computer readable media. Computer readable storage media refers to any non-transitory tangible storage medium that participates in providing instructions and/or data to the controller 2002 for execution and/or processing. Examples of such storage media include floppy disks, magnetic tape, CD-ROM, a hard disk drive, a ROM or integrated circuit, USB memory, a magneto-optical disk, flash memory, or a computer readable card such as a PCMCIA card and the like, whether or not such devices are internal or external of the print system 2001. Examples of computer readable transmission media that may also participate in the provision of software, application programs, instructions and/or data to the print system 2001 include radio or infra-red transmission channels as well as a network connection to another computer or networked device, and the Internet or Intranets including e-mail transmissions and information recorded on Websites and the like. A computer readable medium having such software or computer program recorded on it is a computer program product.

The second part of the APV application programs 2033 and the corresponding code modules mentioned above may be executed to implement one or more graphical user interfaces (GUIs) to be rendered or otherwise represented upon the display 2014 of FIG. 20A. Through manipulation of the user input device 2013 (e.g., the keypad), a user of the print system 2001 and the application programs 2033 may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers (not illustrated) and user voice commands input via the microphone (not illustrated).

FIG. 20B illustrates in detail the embedded controller 2002 having the processor 301 for executing the APV application programs 2033 and the internal storage 323. The internal storage 323 comprises read only memory (ROM) 2060 and random access memory (RAM) 2070. The processor 301 is able to execute the APV application programs 2033 stored in one or both of the connected memories 2060 and 2070. When the electronic device 2002 is initially powered up, a system program resident in the ROM 2060 is executed. The application program 2033 permanently stored in the ROM 2060 is sometimes referred to as “firmware”. Execution of the firmware by the processor 301 may fulfil various functions, including processor management, memory management, device management, storage management and user interface.

The processor 301 typically includes a number of functional modules including a control unit (CU) 2051, an arithmetic logic unit (ALU) 2052 and a local or internal memory comprising a set of registers 2054 which typically contain atomic data elements 2056, 2057, along with internal buffer or cache memory 2055. One or more internal buses 2059 interconnect these functional modules. The processor 301 typically also has one or more interfaces 2058 for communicating with external devices via system bus 2081, using a connection 2061.

The APV application program 2033 includes a sequence of instructions 2062 though 2063 that may include conditional branch and loop instructions. The program 2033 may also include data, which is used in execution of the program 2033. This data may be stored as part of the instruction or in a separate location 2064 within the ROM 2060 or RAM 2070.

In general, the processor 301 is given a set of instructions, which are executed therein. This set of instructions may be organised into blocks, which perform specific tasks or handle specific events that occur in the print system 2001. Typically, the APV application program 2033 waits for events and subsequently executes the block of code associated with that event. Events may be triggered in response to input from a user, via the user input devices 2013 of FIG. 20A, as detected by the processor 301. Events may also be triggered in response to other sensors and interfaces in the print system 2001. The execution of a set of the instructions may require numeric variables to be read and modified. Such numeric variables are stored in the RAM 2070. The disclosed method uses input variables 2071 that are stored in known locations 2072, 2073 in the memory 2070. The input variables 2071 are processed to produce output variables 2077 that are stored in known locations 2078, 2079 in the memory 2070. Intermediate to variables 2074 may be stored in additional memory locations in locations 2075, 2076 of the memory 2070. Alternatively, some intermediate variables may only exist in the registers 2054 of the processor 301.

The execution of a sequence of instructions is achieved in the processor 301 by repeated application of a fetch-execute cycle. The control unit 2051 of the processor 301 maintains a register called the program counter, which contains the address in ROM 2060 or RAM 2070 of the next instruction to be executed. At the start of the fetch execute cycle, the contents of the memory address indexed by the program counter is loaded into the control unit 2051. The instruction thus loaded controls the subsequent operation of the processor 301, causing for example, data to be loaded from ROM memory 2060 into processor registers 2054, the contents of a register to be arithmetically combined with the contents of another register, the contents of a register to be written to the location stored in another register and so on. At the end of the fetch execute cycle the program counter is updated to point to the next instruction in the system program code. Depending on the instruction just executed this may involve incrementing the address contained in the program counter or loading the program counter with a new address in order to achieve a branch operation.

Each step or sub-process in the processes of the APV methods described below is associated with one or more segments of the application program 2033, and is performed by repeated execution of a fetch-execute cycle in the processor 301 or similar programmatic operation of other independent processor blocks in the print system 2001.

FIG. 1 is a top-level flow chart showing the flow of determining if a page contains unexpected differences. In particular, FIG. 1 provides a high-level overview of a flow chart of a process for performing colour imaging according to a preferred APV arrangement running on the printer 300 including a verification unit 330. The verification unit 330 is shown in more detail in FIG. 21.

FIG. 21 shows the details of the print defect detection system 330 of FIG. 3, which forms part of the special function module 2010 in FIG. 20A. The system 330 which performs the noted verification process employs an image inspection device (eg the image capture system 2108) to assess the quality of output prints by detecting unexpected print differences generated by the print engine 329 which performs the printing step 130 in the arrangement in FIG. 1. The source input document 166 to the system is, in the present example, a digital document expressed in the form of a page description language (PDL) script, which describes the appearance of document pages. Document pages typically contain text, graphical elements (line-art, graphs, etc) and digital images (such as photos). The source input document 166 can also be referred to as a source image, source image data and so on.

In a rendering step 120 the source document 166 is rendered using a rasteriser (under control of the CPU 301 executing the APV software application 2033), by processing the PDL, to generate a two-dimensional bitmap image 160 of the source is document 166. This two dimensional bitmap version 160 of the source document 166 is referred to as the original image 160 hereinafter. In addition, the rasteriser can generate alignment information (also referred to as alignment hints) that can take the form of a list 162 of regions of the original image 160 with intrinsic alignment structure (referred to as “alignable” regions hereinafter). The rendered original image 160 and the associated list of alignable regions 162 are temporarily stored in the printer memory 323.

Upon completing processing in the step 120, the rendered original image 160 is sent to a colour printer process 130. The colour printer process 130 uses the print engine 329, and produces the output print 163 by forming a visible image on a print medium such as the paper sheet 319 using the print engine 329. The rendered original image 160 in the image memory is transferred in synchronism with (a) a sync signal and clock signal (not shown) required for operating the print engine 329, and (b) a transfer request (not shown) of a specific colour component signal or the like, via the bus 312. The rendered original image 160 together with the generated alignment data 162 is also sent (a) to the memory 2104 of the print verification unit 330 via the bus 312 and (b) the print verification unit I/O unit 2105, for use in a subsequent defect detection process 150.

The output print 163 (which is on the paper sheet 319 in the described example) that is generated by the colour print process 130 is scanned by an image capturing process 140 using, for example, the image capture system 2108. The image capturing system 2108 may be a colour line scanner for real-time imaging and processing. However, any image capturing device that is capable of digitising and producing high quality digital copy of printouts can be used.

In one APV arrangement as depicted in FIG. 21, the scanner 2108 can be configured to capture an image of the output print 163 from the sheet 319 on a scan-line by scan-line basis, or on a strip by strip basis, where each strip comprises a number of scan lines. The captured digital image 164 (ie the scan image) is sent to the print defect detection process 150 (performed by the APV Application Specific Integrated Circuit ASIC 2107 and/or the APV software 2103 application), which aligns and compares the original image 160 and the scan image 164 using the alignment data 162 from the rendering process 120 in order to locate and identify print defects. Upon completion, the print defect detection process 150 outputs a defect map 165 indicating defect types and locations of all detected defects. This is used to make a decision on the quality of the page in a decision step 170, which produces a decision signal 175. This decision signal 175 can then be used to trigger an automatic reprint or alert the user. In one is implementation, the decision signal 175 is set to “1” (error present) if there are more than 10 pixels marked as defective in the defect map 165, or is set to “0” (no error) otherwise.

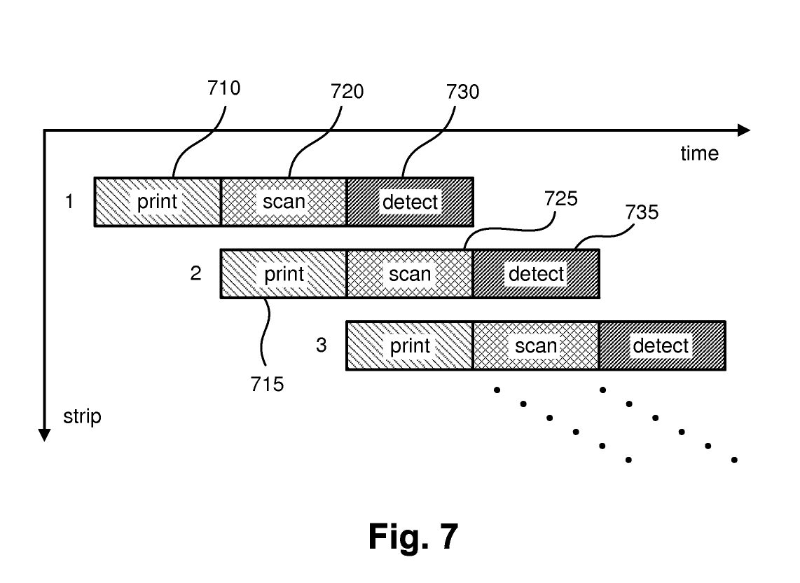

FIG. 7 and FIG. 21 show how, in a preferred APV arrangement, the printing process 130, the scanning process 140 and the defect detection process 150 can be arranged in a pipeline. In this arrangement, a section (such as a strip 2111) of the rendered original image 160 is printed by the print system engine 329 to form a section of the output print 163 on the paper sheet 319. When a printed section 2111 of the output print 163 moves to a position 2112 under the image capture system 2108, it is scanned by the scanning process 140 using the image capture system 2108 to form part of the scanned image 164. The scan of section 2112, as a strip of scan-lines, is sent to the print defect zs detection process 150 for alignment and comparison with the corresponding rendered section of the original image 160 that was sent to the print engine 329.

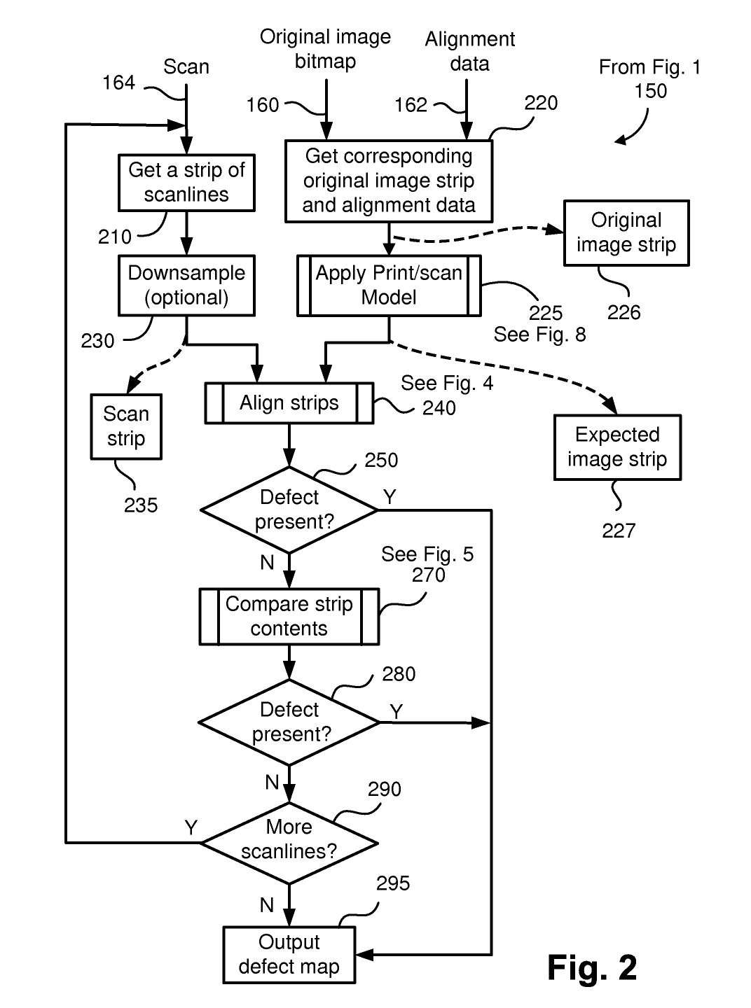

FIG. 7 shows a graphical view of how the steps of FIG. 2 can be performed in parallel. In particular, FIG. 7 shows that as the page 319 moves in the feed direction 314, a first section of the rendered original image 160 is printed 710 by the print system engine 329 to form a next section of the printed image 163. The next printed section on the printed image 163 is scanned 720 by the scanning process 140 using the scanner 2108 to form a first section of the scanned image 164. The first scanned section is then sent 730 to the print defect detection process 150 for alignment and comparison with the first rendered section that was sent to the print system engine 329. A next section of the rendered original image 160 is processed 715, 725, 735 in the same manner as shown in FIG. 7. Thus, the pipeline arrangement allows all three processing stages to occur concurrently after the first two sections.

Returning to FIG. 1, it is advantageous, during rasterisation in the step 120, to perform an image analysis on the rendered original image 160 in order to identify the alignable regions 162 which provide valuable alignment hints to the print defect detection step 150 as shown in FIG. 1. Accurate registration of the original image 160 and the printout scan image 164 enables image quality metric evaluation to be performed on a pixel-to-pixel basis. One of the significant advantages of such an approach is that precise image alignment can be performed without the need to embed special registration marks or patterns explicitly in the source input document 166 and/or the original image 160. The image analysis performed in the rendering step 120 to determine the alignment hints may be based on Harris corners.

The process of detecting Harris corners is described in the following example. Given an A4 size document rendered at 300 dpi, the rasteriser process in the step 120 is generates the original image 160 with an approximate size of 2500 by 3500 pixels. The first step for detecting Harris corners is to determine the gradient or spatial derivatives of a grey-scale version of the original image 160 in both x and y directions, denoted as Iₓ and I_{y}. In practice, this can be approximated by converting the rendered document 160 to greyscale and applying the Sobel operator to the greyscale result. To convert the original image 160 to greyscale, if the original image 160 is an RGB image, the following method [1] can be used:

I_{G}=R_{y11}Iᵣ+R_{y12}I_{g}+R_{y13}I_{b} [1]

where I_{G} is the greyscale output image, Iᵣ, I_{g}, and I_{b} are the Red, Green, and Blue image components, and the reflectivity constants are defined as R_{y11}=0.2990, R_{y12}=0.5870, and R_{y13}=0.1140.

An 8-bit (0 to 255) encoded CMYK original image 160 can be similarly converted to greyscale using the following simple approximation [2]:

I_{G}=R_{y11}MAX(255−I_{c}−Iₖ,0)+R_{y12}MAX(255−Iₘ−Iₖ,0)+R_{y13}MAX(255−I_{y}−Iₖ,0) [2]

Other conversions may be used if a higher accuracy is required, although it is generally sufficient in this step to use a fast approximation.

The Sobel operators use the following kernels [3]:

$${S}_{x} = [ \begin{matrix}- 1 & 0 & 1 \\ - 2 & 0 & 2 \\ - 1 & 0 & 1\end{matrix} ] \\ {S}_{y} = [ \begin{matrix}- 1 & - 2 & - 1 \\ 0 & 0 & 0 \\ 1 & 2 & 1\end{matrix} ] \qquad [ 3 ]$$

Edge detection is performed with the following operations [4]:

Iₓ=Sₓ*I_{G}

I_{y}=S_{y}*I_{G} [4]

where * is the convolution operator, I_{G} is the greyscale image data, Sₓ,S_{y} are the kernels defined above, and Iₓ and I_{y} are images containing the strength of the edge in the x and y direction respectively. From Iₓ and I_{y}, three images are produced as follows [5]:

Iₓₓ=Iₓ∘Iₓ

I_{xy}=Iₓ∘I_{y}

I_{yy}=I_{y}∘I_{y} [4]

where ∘ is a pixel-wise multiplication.

This allows a local structure matrix A to be calculated over a neighbourhood around each pixel, using the following relationship [6]:

$$A = {\sum }_{x , y} w ( x , y ) [ \begin{matrix}{I}_{x}^{2} & {I}_{x} {I}_{y} \\ {I}_{x} {I}_{y} & {I}_{y}^{2}\end{matrix} ] , \qquad [ 6 ]$$

where w(x, y) is a windowing function for spatial averaging over the neighbourhood. In a preferred APV arrangement w(x, y) can be implemented as a Gaussian filter with a standard deviation of 10 pixels. The next step is to form a “cornerness” image by determining the minimum eigenvalue of the local structure matrix at each pixel location. The cornerness image is a 2D map of the likelihood that each pixel is a corner. A pixel is classified as a corner pixel if it is the local maximum (that is, has a higher cornerness value than its 8 neighbours).

A list of all the corner points detected, C_{corners}, together with the strength (cornerness) at that point is created. The list of corner points, C_{corners}, is further filtered by deleting points which are within S pixels from another, stronger, corner point. In the current APV arrangement, S=64 is used.

The list of accepted corners, C_{new}, is output to the defect detection step 150 as a list 162 of alignable regions for use in image alignment. Each entry in the list can be described by a data structure comprising three data fields for storing the x-coordinate of the centre of the region (corresponding to the location of the corner), the y-coordinate of the centre of the region, and the corner strength of the region.

Alternatively, other suitable methods for determining feature points in the original image 160 such as Gradient Structure Tensor or Scale-Invariant Feature Transform (SIFT) can also be used.

In another APV arrangement, the original image 160 is represented as a multi-scale image pyramid in the step 120, prior to determining the alignable regions 162. The image pyramid is a hierarchical structure composed of a sequence of copies of the original image 160 in which both sample density and resolution are decreased in regular steps. This approach allows image alignment to be performed at different resolutions, providing an efficient and effective method for handling output prints 163 on different paper sizes or printout scan images 164 at different resolutions.

FIG. 2 is a flow-chart showing the details of step 150 of FIG. 1. FIG. 2 illustrates in detail the step 150 of FIG. 1. The process 150 works on strips of the original image 160 and the scan image 164. A strip of the scan image 164 corresponds to a strip 2112 of the page 319 scanned by the scanner 2108. For some print engines 329, the image is produced in strips 2111, so it is sometimes convenient to define the size of the two strips 2111, 2112 to be the same. A strip of the scan image 164, for example, is a number of consecutive image lines stored in the memory buffer 2104. The height 2113 of each strip is 256 scanlines in the present APV arrangement example, and the width 2114 of each strip may be the width of the input image 160. In the case of an A4 original document 160 at 300 dpi, the width is 2490 pixels. Image data on the buffer 2104 is updated continuously in a “rolling buffer” arrangement where a fixed number of scanlines are acquired by the scanning sensors 2108 in the step 140, and stored in the buffer 2104 by flushing an equal number of scanlines off the buffer in a first-in-first-out (FIFO) manner. In one APV arrangement example, the number of scanlines acquired at each scanner sampling instance is 64.

Processing of the step 150 begins at a scanline strip retrieval step 210 where the memory buffer 2104 is filled with a strip of image data from the scan image 164 fed by the scanning step 140. In one APV arrangement example, the scan strip is optionally downsampled in a downsampling step 230 using a separable Burt-Adelson filter to reduce the amount of data to be processed, to thereby output a scan strip 235 which is a strip of the scan image 164.

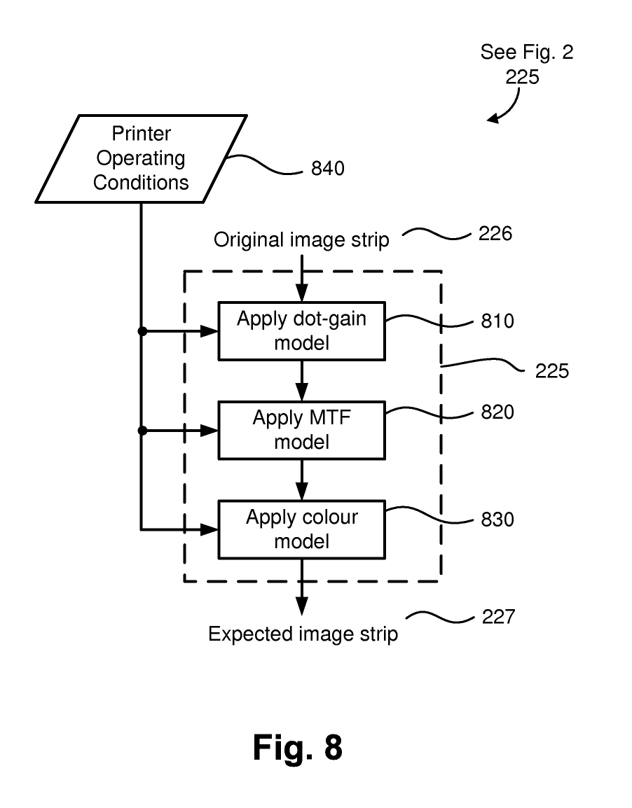

Around the same time, a strip of the original image 160 at the corresponding resolution and location as the scan strip, is obtained in an original image strip and alignment data retrieval step 220. Furthermore, the list of corner points 162 generated during rendering in the step 120 for image alignment is passed to the step 220. Once the corresponding original image strip has been extracted in the step 220, a model of the print and capture process (hereafter referred to as a “print/scan model” or merely as a “model”) is applied at a model application step 225, which is described in more detail in regard to FIG. 8. The print/scan model applies a set of transforms to the original image 160 to change it in some of the ways that it is changed by the true print and capture processes. These transforms produce an image representing the expected output of a print and scan process, referred to as the “expected image”. The print/scan model may include many smaller component models.

FIG. 8 is a flow-chart showing the details of step 225 of FIG. 2. In the example of FIG. 8, three important effects are modelled, namely a dot-gain model 810, an MTF (Modulation Transfer Function) model 820 used, for example, for blur simulation, and a colour model 810. Each of these smaller models can take as an input the printer operating conditions 840. Printer operating conditions are various aspects of machine state which have an impact on output quality of the output print 163. Since the operating conditions 840 are, in general, time varying, the print/scan model application step 225 will also be time varying, reflecting the time varying nature of the operating conditions 840. Operating conditions can be determined based on data derived from print system sensor outputs and environmental sensor outputs. This operating condition data is used to characterise and model the current operation of the print mechanism. This printer model allows a digital source document to be rendered with an appearance that resembles a printed copy of the document under those operating conditions.

Examples of printer operating conditions include the output of a sensor that detects the type of paper 319 held in the input tray 315, the output of a sensor that monitors the drum age (the number of pages printed using the current drum (not shown) in the image forming units 302-305, also known as the drum's “click count”), the output of a sensor that monitors the level and age of toner/ink in the reservoirs 307-310, the output of a sensor that measures the internal humidity inside the print engine 329, the output of a sensor that measures the internal temperature in the print system 300, the time since the last page was printed (also known as idle time), the time since the machine last performed a self-calibration, pages printed since last service, and so on. These operating conditions are measured by a number of operating condition detectors for use in the print process or to aid service technicians, implemented using a combination of sensors (eg, a toner level sensor for toner level notification in each of the toner reservoirs 307-310, a paper type sensor, or a temperature and humidity sensor), a clock (eg, to measure the time since the last print), and internal counters (eg, the number of pages printed since the last service). For example, if the toner level sensor indicates a low level of toner, the printer model is adapted in such a way that the rendered digital document would have an appearance that resembles a printed page with faint colours. Each of the models will now be described in more detail.

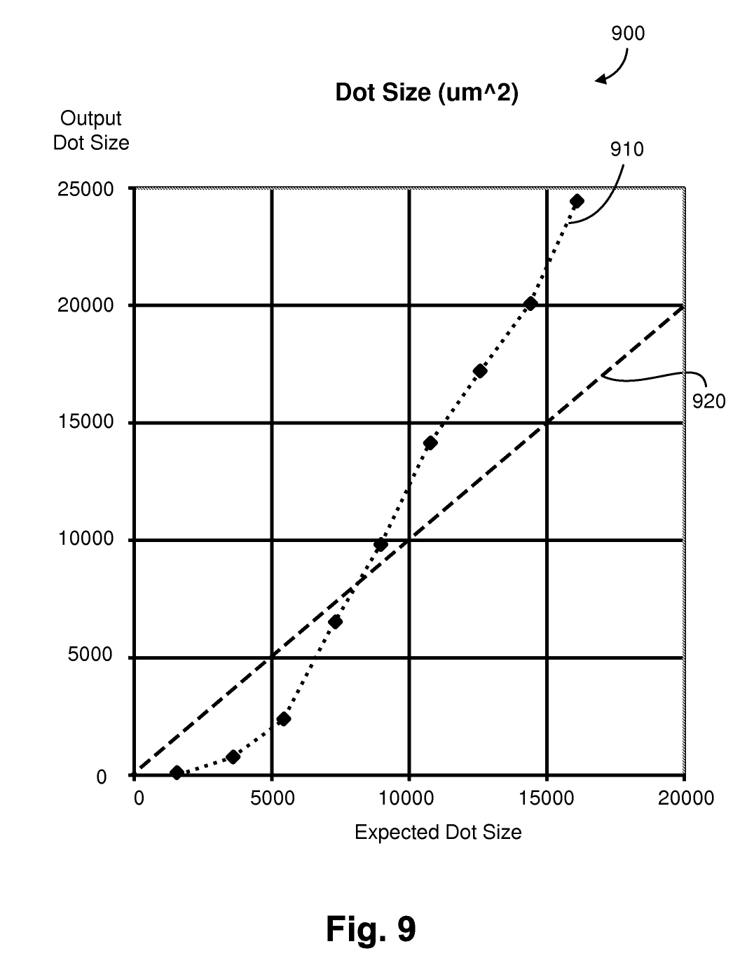

In the dot-gain model step 810, the image is adjusted to account for dot-gain. Dot-gain is the process by which the size of printed dots appears larger (known as positive dot-gain) or smaller (known as negative dot-gain) than the ideal size. For example, FIG. 9 shows a typical dot-gain curve graph 900.

FIG. 9 illustrates a typical dot-gain curve 910 of an electrophotographic system. The ideal result 920 of printing and scanning different size dots is that the observed (output) dot size will be equal to the expected dot size. A practical result 910 may have the characteristic shown where very small dots (less than 5 pixels at 600 DPI in the is example graph 900) are observed as smaller than expected, and larger dots (5 pixels or greater in the example graph 900) are observed as larger than expected. Dot-gain can vary according to paper type, humidity, drum click count, and idle time. Some electrophotographic machines with 4 separate drums can have slightly different dot-gain behaviours for each colour, depending on the age of each drum. Dot-gain is also typically zo not isotropic, and can be larger in a process direction than in another direction. For example, the dot-gain on an electrophotographic process may be higher in the direction of paper movement. This can be caused by a squashing effect of the rolling parts on the toner. In an inkjet system, dot-gain may be higher in the direction of head movement relative to the paper. This can be caused by air-flow effects which can spread a single dot into multiple droplets.

In one implementation for an electrophotographic process, an approximate dot-gain model can be implemented as a non-linear filter on each subtractive colour channel (eg, C/M/Y/K channels) as depicted in [7] as follows:

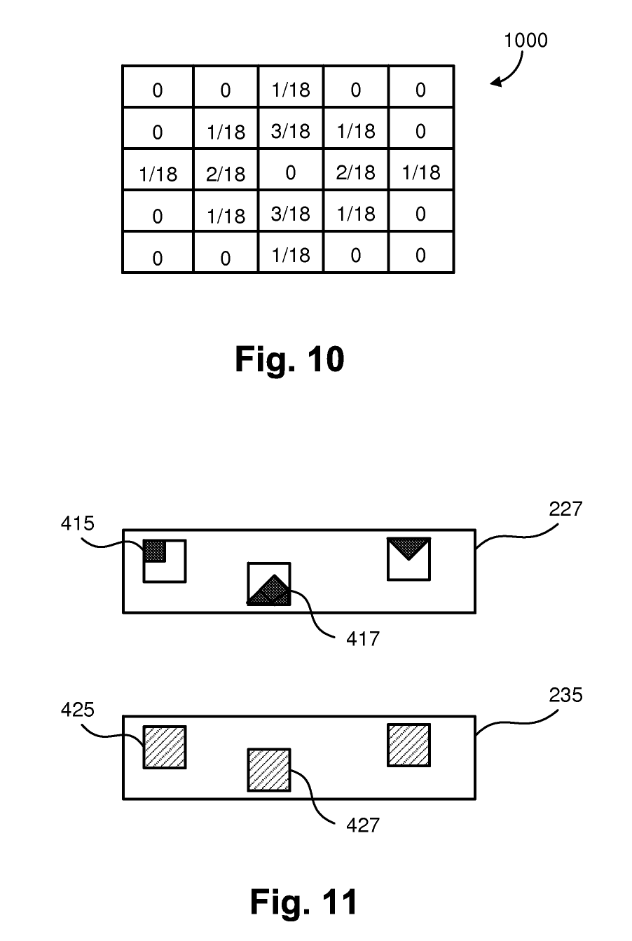

I_{d}=I+M∘(I*s∘K)) [7]

where I is the original image 160 for the colour being processed, K is the dot-gain kernel for the colour being processed, M is a mask image, and I_{d} is the resulting dot-gained image. The mask image M is defined as a linearly scaled version of the original image 160 such that 1 is white (no ink/toner), and 0 is full coverage of ink/toner. An example dot-gain kernel 1000 which can be used for K is shown in FIG. 10. The dot-gain kernel 1000 produces a larger effect in the vertical direction, which is assumed to be the process direction in this case. The effect of the dot-gain kernel K is scaled by a scale factors, which is defined as follows [8]:

$$s = ( d + MIN [ 0.2 , \frac{t}{10} ] ) \qquad [ 8 ]$$

where d is the drum lifetime, and t is the idle time. Drum lifetime d is a value ranging between 0 (brand new) and 1 (due for replacement). A typical method for measuring the d factor counts the number of pages that have been printed using the colour of the given drum, and divides this by the expected lifetime in pages. The idle time t of the machine, measured in days, is also included in this model.

This is only one possible model for dot-gain which utilises some of the operating conditions 840, and the nature of dot-gain is dependant on the construction of the print engine 329.

In another implementation for an ink-jet system, a set of dot-gain kernels can be pre-calculated for each type of paper, and a constant scale factor s=1.0 can be used. The dot-gain of inkjet print systems can vary strongly with paper type. Particularly, plain is paper can show a high dot gain due to ink wicking within the paper. Conversely, photo papers (which are often coated with a transparent ink-carrying layer) can show a small but consistent dot-gain due to shadows cast by the ink on the opaque paper surface. Such pre-calculated models can be stored in the output checker memory 2104 and accessed according to the type of paper in the input tray 315.

Returning to FIG. 8, the next step after the dot-gain model 810 is an MTF model step 820. MTF can be a complex characteristic in a print/scan system, but may be simply approximated with a Gaussian filter operation. As with dot-gain, MTF varies slightly with drum age factor d, and idle time, t. However, the MTF of the print/scan process is generally dominated by the MTF of the capture process, which may not vary with device operating conditions. In one implementation, the MTF filter step is defined as a simple filter [8A] as follows:

Iₘ=I_{d}*G_{σ} [8A]

where G_{σ} is a Gaussian kernel with standard deviation σ, as is known in the art. In one implementation, σ is chosen as σ=0.7+0.2d. It is also possible to apply this filter more efficiently using known separable Gaussian filtering methods.

Turning to a following colour model application step 830, it is noted that the desired colours of a document can be changed considerably by the process of printing and scanning. In order to detect only the significant differences between two images, it is useful to attempt to match their colours using the colour model step 830. The colour model process assumes that the colour of the original image 160 changes in a way which can be approximated using a simple model. In one APV arrangement, it is assumed that the colour undergoes an affine transformation. However, other suitable models can be used, e.g., a gamma correction model, or an nth order polynomial model.

If the colour undergoes an affine transformation, in the case of a CMYK source image captured as RGB, it is transformed according to the following equation [9]:

$$[ \begin{matrix}{R}_{pred} \\ {G}_{pred} \\ {B}_{pred}\end{matrix} ] = [ \begin{matrix}{A}_{11} & {A}_{12} & {A}_{13} & {A}_{14} \\ {A}_{21} & {A}_{22} & {A}_{23} & {A}_{24} \\ {A}_{31} & {A}_{32} & {A}_{33} & {A}_{34}\end{matrix} ] [ \begin{matrix}{C}_{orig} \\ {M}_{orig} \\ {Y}_{orig} \\ {K}_{orig}\end{matrix} ] + [ \begin{matrix}{C}_{1} \\ {C}_{2} \\ {C}_{3}\end{matrix} ] = A [ \begin{matrix}{C}_{orig} \\ {M}_{orig} \\ {Y}_{orig} \\ {K}_{orig}\end{matrix} ] + C \qquad [ 9 ]$$

where (R_{pred}, G_{pred}, B_{pred}) are the predicted RGB values of the original image 160 after printing in the step 130 and scanning in the step 140 according to this predefined model, (C_{orig}, M_{orig}, Y_{orig} K_{orig}) are the CMYK values of the original image 160, and A and C are the affine transformation parameters.

Similarly, an RGB source image captured in RGB undergoes a simpler transformation as follows [10]:

$$[ \begin{matrix}{R}_{pred} \\ {G}_{pred} \\ {B}_{pred}\end{matrix} ] = [ \begin{matrix}{B}_{11} & {B}_{12} & {B}_{13} \\ {B}_{21} & {B}_{22} & {B}_{23} \\ {B}_{31} & {B}_{32} & {B}_{33}\end{matrix} ] [ \begin{matrix}{R}_{orig} \\ {G}_{orig} \\ {B}_{orig}\end{matrix} ] + [ \begin{matrix}{D}_{1} \\ {D}_{2} \\ {D}_{3}\end{matrix} ] = B [ \begin{matrix}{R}_{orig} \\ {G}_{orig} \\ {B}_{orig}\end{matrix} ] + D \qquad [ 10 ]$$

In one implementation example, the parameters A, B and C, D are chosen from a list of pre-determined options. The choice may be made based on the operating conditions of paper type of the page 319, toner/ink types installed in the reservoirs 307-310, and the time which has elapsed since the printer last performed a self-calibration. The parameters A, B and C, D may be pre-determined for the given paper and toner combinations using known colour calibration methods.

Once the colour model step 830 has been processed, the model step 225 is complete and the resulting image is the expected image strip 227.

Returning to FIG. 2, the scan strip 235 and the expected image strip 227 are then processed by a strip alignment step 240 that is performed by the processor 2106 as directed by the APV ASIC 2107 and/or the APV software application program 2103. The step 240 performs image alignment of the scan strip 235 and the expected image strip 227 using the list of alignment regions (ie alignment hints) 162. As the model step 225 did not change the coordinate system of the original image strip 226, spatially aligning the coordinates of the scan strip 235 to the expected strip 227 is equivalent to aligning the coordinates to the original image strip 226.

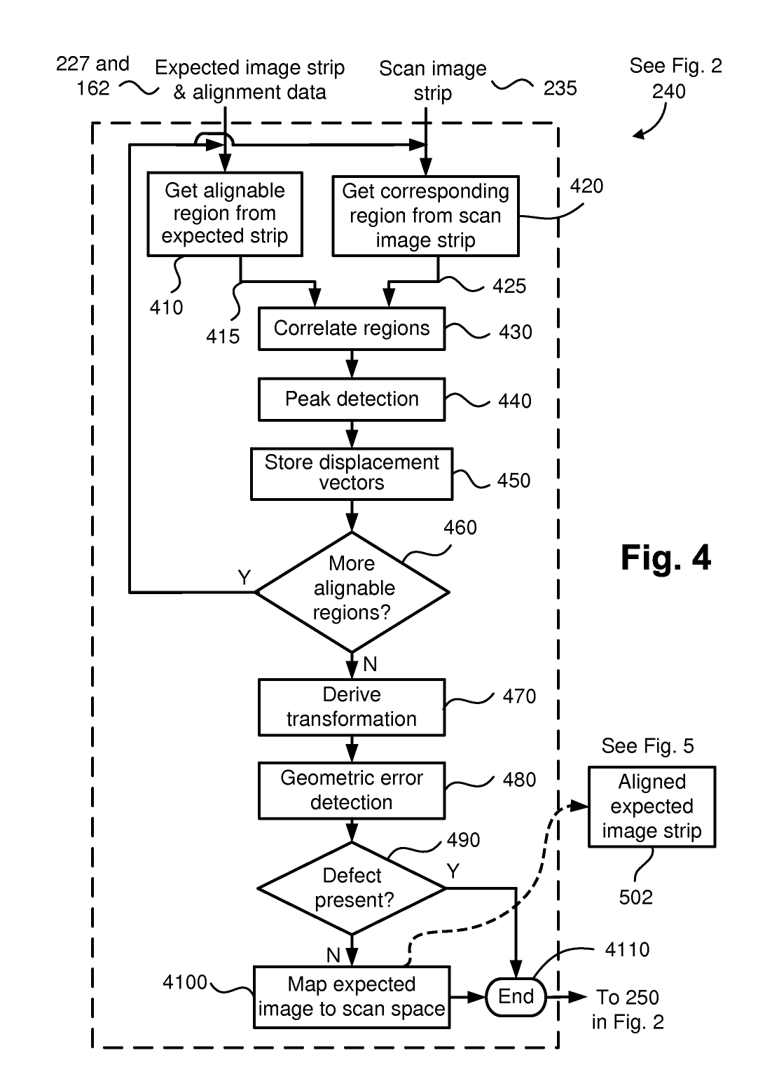

The purpose of this step 240 is to establish pixel-to-pixel correspondence between the scan strip 235 and the expected image strip 227 prior to a comparison process in a step 270. It is noted that in order to perform real-time print defect detection, a fast and accurate image alignment method is desirable. A block based correlation technique where correlation is performed for every block in a regular grid is inefficient. Furthermore, the block based correlation does not take into account whether or not a block contains image structure that is intrinsically alignable. Inclusion of unreliable correlation results can affect the overall image alignment accuracy. The present APV arrangement example overcomes the above disadvantages of the block based correlation by employing a sparse image alignment technique that accurately estimates a geometrical transformation between the images using alignable regions. The alignment process 240 will be described in greater detail with reference to FIG. 4 below.

In a following step 250, a test is performed by the processor 2106 as directed by the APV ASIC 2107 and/or the APV software application program 2103 to determine if any geometric errors indicating a misalignment condition (eg. excessive shift, skew, etc) were detected in the step 240 (the details of this test are described below with reference to FIG. 4). If the result of this test is Yes, processing moves to a defect map output step 295. Otherwise processing continues at a strip content comparison step 270.

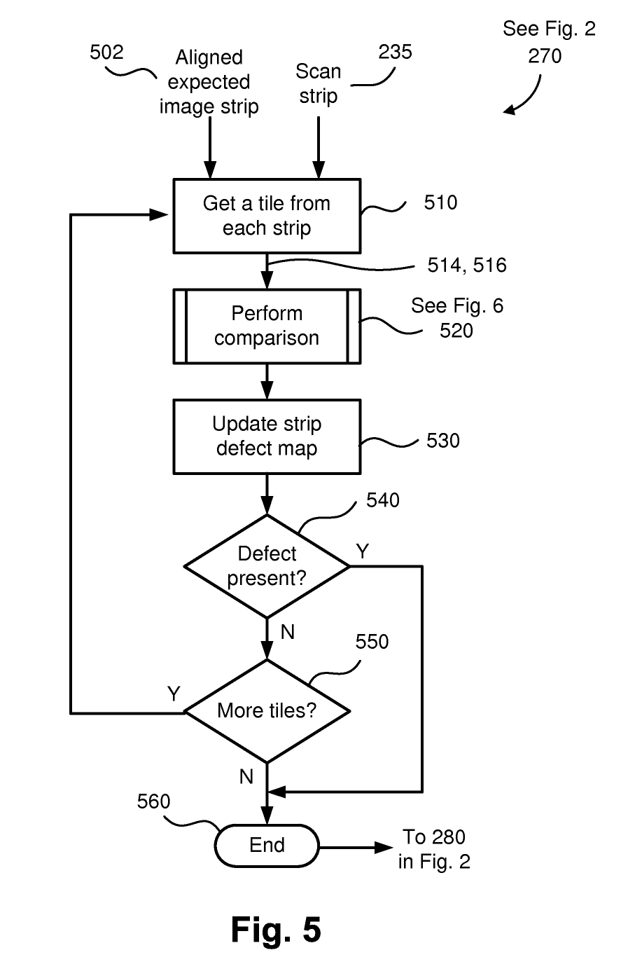

As a result of processing in the step 240, the two image strips are accurately zo aligned with pixel-to-pixel correspondence. The aligned image strips are further processed by the step 270, performed by the processor 2106 as directed by the APV ASIC 2107 and/or the APV software application program 2103, which compares the contents of the scan strip 235 and the expected image strip 227 to locate and identify print defects. The step 270 will be described in greater detail with reference to FIG. 5 below.

Following the step 270, a check is made at a decision step 280 to determine if any print defects were detected in the step 270. If the result of step 280 is No, processing continues at a step 290. Otherwise processing continues at the step 295. The step 290 determines if there are any new scanlines from the scanner 2108 from the step 140 to be processed. If the result of the step 290 is Yes, processing continues at the step 210 where the existing strip in the buffer is rolled. That is, the top 64 scanlines are removed and the rest of the scanlines in the buffer are moved up by 64 lines, with the final 64 lines replaced by the newly acquired scanlines from the step 140. If the result of the step 290 is No, processing continues at the step 295, where the defect map 165 is updated. The step 295 concludes the detect defects step 150, and control returns to the step 170 in FIG. 1.

Returning to FIG. 1, a decision is then made in the decision step 170 as to the acceptability of the output print 163.

When evaluating a colour printer, such as a CMYK printer 300, it is desirable to also measure the alignment of different colour channels. For example, the C (cyan) channel of an output print 163 printed by the cyan image forming unit 302 may be several pixels offset from other channels produced by units 303-305 due to mechanical inaccuracy in the printer. This misregistration leads to noticeable visual defects in the output print 163, namely visible lines of white between objects of different colour, or colour fringing that should not be present. Detecting such errors is an important property of a print defect to detection system.

Colour registration errors can be detected by comparing the relative spatial transformations between the colour channels of the scan strip 235 and those of the expected image strip 227. This is achieved by first converting the input strips from the RGB colour space to CMYK. The alignment process of the step 240 is then performed is between each of the C, M, Y and K channels of the scan strip 235 and those of the expected image strip 227 in order to produce an affine transformation for each of the C, M, Y and K channels. Each transformation shows the misregistration of the corresponding colour channel relative to the other colour channels. These transformations may be supplied to a field engineer to allow physical correction of the misregistration problems, or alternately, they may be input to the printer for use in a correction circuit that digitally corrects for the printer colour channel misregistration.

FIG. 4 is a flow-chart showing the details of step 240 of FIG. 2. FIG. 4 depicts the alignment process 240 in greater detail, depicting a flow diagram of the steps for performing the image alignment step 240 in FIG. 2. The step 240 operates on two image strips, those being the scan image strip 235 and the expected image strip 227, and makes use of the alignment hint data 162 derived in the step 120. In a step 410, an alignable region 415 is selected, based upon the list of alignable regions 162, from a number of pre-determined alignable regions from the expected image strip. The alignable region 415 is described by a data structure comprising three data fields for storing the x-coordinate of the centre of the region, the y-coordinate of the centre of the region, and the corner strength of the region. In a step 420 a region 425 from the scan image strip 235, corresponding to the alignable region, is selected from the scan image strip 235. The corresponding image region 425 is determined using a transformation derived from a previous alignment operation on a previous document image or strip to transform the x and y coordinates of the alignable region 415 to its corresponding location (x and y coordinates) in the scan image strip 235. This transformed location is the centre of the corresponding image region 425.

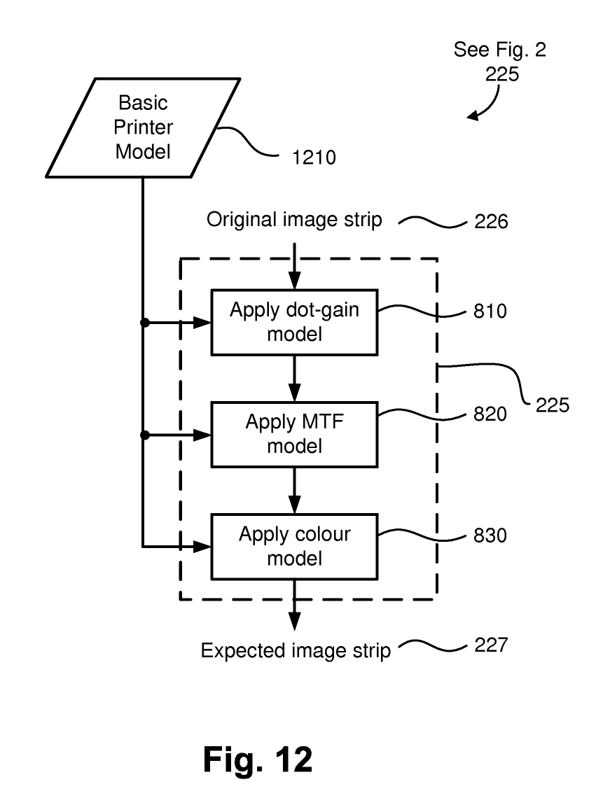

FIG. 11 shows the detail of two strips which, according to one example, can be input to the alignment step 240 of FIG. 2. In particular, FIG. 11 illustrates examples of the expected image strip 227 and the scan image strip 235. Relative positions of an example alignable region 415 in the expected image strip 227 and its corresponding region 425 in the scan image strip 235 are shown. Phase only correlation (hereinafter known as phase correlation) is then performed, by the processor 2106 as directed by the APV ASIC 2107 and/or the APV arrangement software program 2103, on the two regions 415 and 425 to determine the translation that best relates the two regions 415 and 425. A next pair of regions, shown as 417 and 427 in FIG. 11, are then selected from the expected image strip 227 and the scan image strip 235. The region 417 is another alignable region and the region 427 is the corresponding region as determined by the transformation between the two images. Correlation is then repeated between this new pair of regions 417 and 427. These steps are repeated until all the alignable regions 162 within the expected image strip 227 have been processed. In one APV arrangement example, the size of an alignable region is 64 by 64 pixels.

Returning to FIG. 4, a following phase correlation step 430 begins by applying a window function such as a Hanning window to each of the two regions 415 and 425, and the two windowed regions are then phase correlated. The result of the phase correlation in the step 430 is a raster array of real values. In a following peak detection step 440 the location of a highest peak is determined within the raster array, with the location being relative to the centre of the alignable region. A confidence factor for the peak is also determined, defined as the height of the detected peak relative to the height of the second peak, at some suitable minimum distance from the first, in the correlation result. In one implementation, the minimum distance chosen is a radius of 5 pixels. The location of the peak, the confidence, and the centre of the alignable region are then stored in a system memory location 2104 in a vector displacement storage step 450. If it is determined in a following decision step 460 that more alignable regions exist, then processing moves back to the steps 410 and 420, where a next pair of regions (eg, 417 and 427) is selected. Otherwise processing continues to a transformation derivation step 470.

In an alternative APV arrangement, binary correlation may be used in place of phase correlation.

The output of the phase correlations is a set of displacement vectors D(n) that represents the transformation that is required to map the pixels of the expected image strip 227 to the scan image strip 235.

Processing in the step 470 determines a transformation from the displacement vectors. In one APV arrangement example, the transformation is an affine transformation with a set of linear transform parameters (b₁₁, b₁₂, b₂₁, b₂₂, Δx, Δy), that best relates the displacement vectors in the Cartesian coordinate system as follows [11]:

$$( \begin{matrix}{\tilde{x}}_{n} \\ {\tilde{y}}_{n}\end{matrix} ) = ( \begin{matrix}{b}_{11} & {b}_{21} \\ {b}_{12} & {b}_{22}\end{matrix} ) ( \begin{matrix}{x}_{n} \\ {y}_{n}\end{matrix} ) + ( \begin{matrix}Δ x \\ Δ y\end{matrix} ) \qquad [ 11 ]$$

where (xₙ, yₙ) are alignable region centres and (\tilde{x}ₙ, \tilde{y}ₙ) are affine transformed points.

In addition, the points (xₙ, yₙ) are displaced by the displacement vectors D(n) to give the displaced points (\hat{x}ₙ, ŷₙ) as follows [12]:

(\hat{x}ₙ, ŷₙ)=(xₙ,yₙ)+D(n) [12]

The best fitting affine transformation is determined by minimising the error between the displaced coordinates, (\hat{x}ₙ, ŷₙ), and the affine transformed points (\tilde{x}ₙ, \tilde{y}ₙ) by is changing the affine transform parameters (b₁₁, b₁₂, b₂₁, b₂₂, Δx, Δy). The error functional to be minimised is the Euclidean norm measure E as follows [13]:

$$E = {\sum }_{n = 1}^{N} {( {\hat{x}}_{n} - {\tilde{x}}_{n} )}^{2} + {( {\hat{y}}_{n} - {\tilde{y}}_{n} )}^{2} \qquad [ 13 ]$$

The minimising solution is as follows [14]:

$$( \begin{matrix}{b}_{11} \\ {b}_{12} \\ Δ x\end{matrix} ) = {M}^{- 1} ( \begin{matrix}\sum {\hat{x}}_{n} {x}_{n} \\ \sum {\hat{x}}_{n} {y}_{n} \\ \sum {\hat{x}}_{n}\end{matrix} ) \\ ( \begin{matrix}{b}_{21} \\ {b}_{22} \\ Δ y\end{matrix} ) = {M}^{- 1} ( \begin{matrix}\sum {\hat{y}}_{n} {x}_{n} \\ \sum {\hat{y}}_{n} {y}_{n} \\ \sum {\hat{y}}_{n}\end{matrix} ) \qquad [ 14 ]$$

With the following relationships [15]:

$$M = ( \begin{matrix}{S}_{xx} & {S}_{xy} & {S}_{x} \\ {S}_{xy} & {S}_{yy} & {S}_{y} \\ {S}_{x} & {S}_{y} & S\end{matrix} ) = ( \begin{matrix}\sum {x}_{n} {x}_{n} & \sum {x}_{n} {y}_{n} & \sum {x}_{n} \\ \sum {y}_{n} {x}_{n} & \sum {y}_{n} {y}_{n} & \sum {y}_{n} \\ \sum {x}_{n} & \sum {y}_{n} & \sum 1\end{matrix} ) \\ {M}^{- 1} = \frac{1}{\vert M \vert} ( \begin{matrix}- {S}_{y} {S}_{y} + {SS}_{yy} & - {SS}_{xy} + {S}_{x} {S}_{y} & {S}_{xy} {S}_{y} - {S}_{x} {S}_{yy} \\ - {SS}_{xy} + {S}_{x} {S}_{y} & - {S}_{x} {S}_{x} + {SS}_{xx} & {S}_{x} {S}_{xy} - {S}_{xx} {S}_{y} \\ {S}_{xy} {S}_{y} - {S}_{x} {S}_{yy} & {S}_{x} {S}_{xy} - {S}_{xx} {S}_{y} & - {S}_{xy} {S}_{xy} + {S}_{xx} {S}_{yy}\end{matrix} ) \qquad [ 15 ]$$

And the relationships [16]:

|M|=detM=−SS_{xy}S_{xy}+2SₓS_{xy}S_{y}−SₓₓS_{y}S_{y}−SₓSₓS_{yy}+SSₓₓS_{yy} [16]

where the sums are carried out over all displacement vectors with a peak confidence greater than a threshold Pₘᵢₙ. In one implementation, Pₘᵢₙ is 2.0.

Following the step 470, the set of linear transform parameters (b₁₁, b₁₂, b₂₁, b₂₂, Δx, Δy) is examined in a geometric error detection step 480 to identify geometric errors such as rotation, scaling, shearing and translation. The set of linear transform parameters (b₁₁, b₁₂, b₂₁,b₂₂, Δx, Δy) when considered without the translation is a 2×2 matrix as follows [17]:

$$A = [ \begin{matrix}{b}_{11} & {b}_{21} \\ {b}_{12} & {b}_{22}\end{matrix} ] , \qquad [ 17 ]$$

which can be decomposed into individual transformations assuming a particular order of transformations as follows [18]:

$$[ \begin{matrix}{b}_{11} & {b}_{21} \\ {b}_{12} & {b}_{22}\end{matrix} ] = [ \begin{matrix}{s}_{x} & 0 \\ 0 & {s}_{y}\end{matrix} ] \cdot [ \begin{matrix}1 & 0 \\ {h}_{y} & 1\end{matrix} ] \cdot [ \begin{matrix}cos θ & - sin θ \\ sin θ & cos θ\end{matrix} ] \qquad [ 18 ]$$

where scaling is defined as follows [19]:

$$[ \begin{matrix}{s}_{x} & 0 \\ 0 & {s}_{y}\end{matrix} ] \qquad [ 19 ]$$

where sₓ and s_{y} specify the scale factor along the x-axis and y-axis, respectively.

Shearing is defined as follows [20]:

$$[ \begin{matrix}1 & 0 \\ {h}_{y} & 1\end{matrix} ] or [ \begin{matrix}1 & {h}_{x} \\ 0 & 1\end{matrix} ] \qquad [ 20 ]$$

where hₓ and h_{y} specify the shear factor along the x-axis and y-axis, respectively.

Rotation is defined as follows [21]:

$$[ \begin{matrix}cos θ & - sin θ \\ sin θ & cos θ\end{matrix} ] \qquad [ 21 ]$$

where θ specifies the angle of rotation.

The parameters sₓ, s_{y}, h_{y}, and θ can be computed from the above matrix coefficients by the following [22-25]:

sₓ=\sqrt{b₁₁²+b₂₁²} [22]

$$\begin{matrix}{s}_{y} = \frac{det ( A )}{{s}_{x}} & [ 23 ] \\ {h}_{y} = \frac{{b}_{11} {b}_{12} + {b}_{21} {b}_{22}}{det ( A )} & [ 24 ] \\ tan θ = - \frac{{b}_{21}}{{b}_{11}} & [ 25 ]\end{matrix}$$

In one APV arrangement example, the maximum allowable horizontal or vertical displacement magnitude Δₘₐₓ is 4 pixels for images at 300 dpi, and the acceptable scale factor range (sₘᵢₙ,sₘₐₓ) is (0.98, 1.02), the maximum allowable shear factor magnitude hₘₐₓ is 0.01, and the maximum allowable angle of rotation is 0.1 degree.

However, it will be apparent to those skilled in the art that suitable alternative parameters may be used without departing from the scope and spirit of the APV arrangements, such as allowing for greater translation or rotation.

If the derived transformation obtained in the step 470 satisfies the above affine transformation criteria, then the scan strip 235 is deemed to be free of geometric errors in a following decision step 490, and processing continues at an expected image to scan space mapping step 4100. Otherwise processing moves to an end step 4110 where the step 240 terminates and the process 150 in FIG. 2 proceeds to the step 250 in FIG. 2.

In the step 4100, the set of registration parameters is used to map the expected image strip 227 to the scan image space. In particular, the RGB value at coordinate (xₛ, yₛ) in the transformed image strip is the same as the RGB value at coordinate (x, y) in the expected image strip 227, where coordinate (x, y) is determined by an inverse of is the linear transformation represented by the registration parameters as follows [26]:

$$( \begin{matrix}x \\ y\end{matrix} ) = \frac{1}{{b}_{11} {b}_{22} - {b}_{12} {b}_{21}} ( \begin{matrix}{b}_{22} & - {b}_{21} \\ - {b}_{12} & {b}_{11}\end{matrix} ) ( \begin{matrix}{x}_{s} - Δ x \\ {y}_{s} - Δ y\end{matrix} ) . \qquad [ 26 ]$$

For coordinates (x, y) that do not correspond to pixel positions, an interpolation scheme (bi-linear interpolation in one arrangement) is used to calculate the RGB value for that position from neighbouring values. Following the step 4100, processing terminates at the step 4110, and the process 150 in FIG. 2 proceeds to the step 250.

In an alternative APV arrangement, in the step 4100 the set of registration parameters is used to map the scan image strip 235 to the original image coordinate space. As a result of the mapping in the step 4100, the expected image strip 227 and the scan image strip 235 are aligned.

FIG. 5 is a flow-chart showing the details of the step 270 of FIG. 2. In particular, FIG. 5 depicts the comparison process 270 in more detail, showing a schematic flow diagram of the steps for performing the image comparison. The step 270 operates on two image strips, those being the scan strip 235, and the aligned expected image strip 502, the latter of which resulted from processing in the step 4100.

Processing in the step 270 operates in a tile raster order, in which tiles are made available for processing from top-to-bottom and left-to-right one at a time. Beginning in a step 510, a Q by Q pixel tile is selected from each of the two strips 502, 235 with the tiles having corresponding positions in the respective strips. The two tiles, namely an aligned expected image tile 514 and a scan tile 516 are then processed by a following step 520. In one APV arrangement example, Q is 32 pixels.

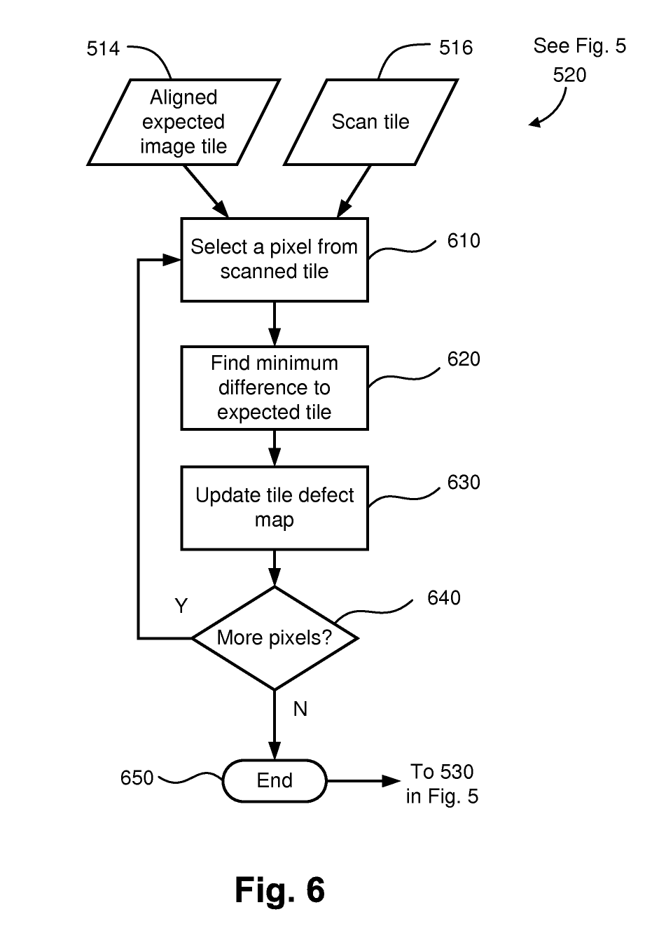

The purpose of the comparison performance step 520, performed by the processor 2106 as directed by the APV ASIC 2107 and/or the APV software application 2103, is to examine a printed region to identify print defects. The step 520 is described in greater detail with reference to FIG. 6.

FIG. 6 is a flow-chart showing the details of step 520 of FIG. 5. In a first step 610, a scan pixel to be checked is chosen from the scan tile 516. In a next step 620, the minimum difference in a neighbourhood of the chosen scan pixel is determined. To determine the colour difference for a single pixel, a colour difference metric is used. In one implementation, the colour difference metric used is a Euclidean distance in RGB space, which for two pixels p and q is expressed as follows [27]:

D_{RGB}(p,q)=\sqrt{(pᵣ−qᵣ)²+(p_{g}−q_{g})²+(p_{b}−q_{b})²} [27]

where pᵣ, p_{g}, p_{b} are the red, green, and blue components of pixel p, and likewise components qᵣ,q_{g}, q_{b} for pixel q. In an alternate implementation, the distance metric used is a Delta E metric, as is known in the art as follows [28]:

D_{ΔE}(p,q)=\sqrt{(p_{L*}−q_{L*})²+(p_{a*}−q_{a*})²+(p_{b*}−q_{b*})²} [28]

Delta E distance is defined using the L*a*b* colour space, which has a known conversion from the sRGB colour space. For simplicity, it is possible to make the approximation that the RGB values provided by most capture devices (such as the scanner 2108) are sRGB values.

The minimum distance between a scan pixel pₛ, at location x,y and nearby pixels in the aligned expected image pₑ, is determined using the chosen metric D according to the following formula [29]:

$${D}_{min} ( {p}_{s} [ x , y ] ) = {min}_{\begin{matrix}{x}^{′} = x - {K}_{B} … x + {K}_{B} \\ {y}^{′} = y - {K}_{B} … y + {K}_{B}\end{matrix}} ( D ( {p}_{s} [ x , y ] , {p}_{e} [ {x}^{′} , {y}^{′} ] ) ) \qquad [ 29 ]$$

where K_{B} is roughly half the neighbourhood size. In one implementation, K_{B} is chosen as 1 pixel, giving a 3×3 neighbourhood.

In a next tile defect map updating step 630, a tile defect map is updated at location x,y based on the calculated value of Dₘᵢₙ. A pixel is determined to be defective if the Dₘᵢₙ value of the pixel is greater than a certain threshold, D_{defect}. In one implementation using D_{ΔE} to calculate Dₘᵢₙ, D_{defect} is set as 10. In the next decision step 640, if there are any more pixels left to process in the scan tile, the process returns to the step 610. If no pixels are left to process, the method 520 is completed at the final step 650 and control returns to a step 530 in FIG. 5. Following processing in the step 520, the tile-based defect map created in the comparison step 630 is stored in the defect map 165 in the strip defect map updating step 530. In a following decision step 540, a check is made to determine if any print defects existed when updating the strip defect map in the step 530. It is noted that the step 530 stores defect location information in a 2D map, and this allows the user to see where defects occurred in the output print 163. The decision step 540, if it returns a “YES” decision, breaks out of the loop once a defect has been detected, and control passes to a termination step 560 as no further processing is necessary. If the result of step the 540 is No, processing continues at a following step 550. Otherwise processing continues at the step 560. The step 550 determines if there are any remaining to tiles to be processed. If the result of the step 550 is Yes, processing continues at the step 510 by selecting a next set of tiles. If the result of 550 is No, processing terminates at the step 560.

### Alternate Embodiment

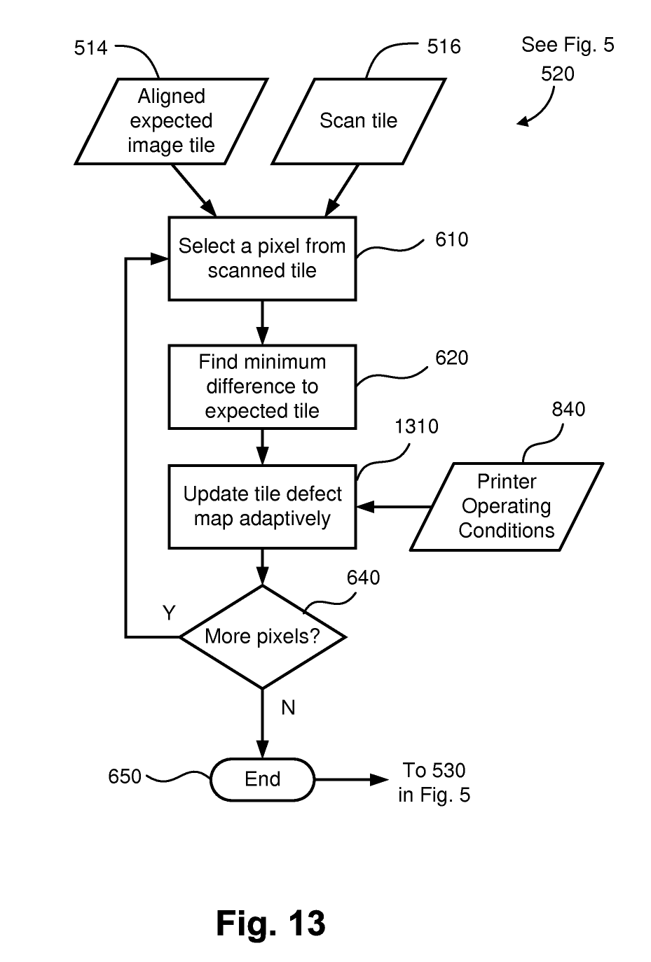

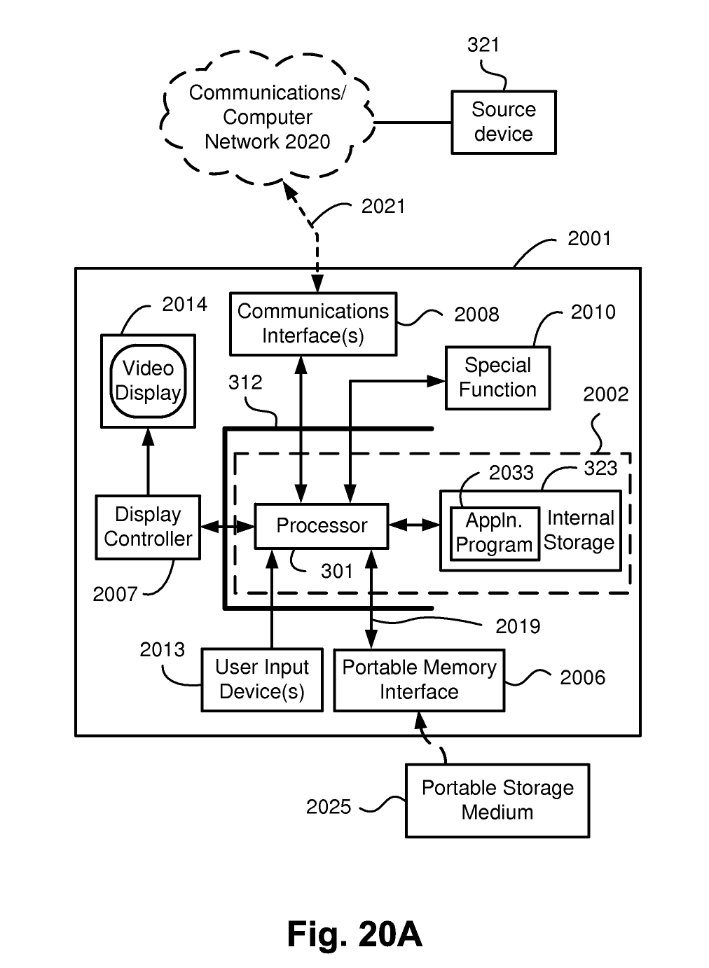

Details of an alternate embodiment of the system are shown in FIG. 12 and FIG. 13.

FIG. 12 shows the process of FIG. 8 as modified in an alternate embodiment. In the alternate embodiment, the printer model applied in the model step 225 is not based on current printer operating conditions 840 as in FIG. 7, but a fixed basic printer model 1210 is used. Since the printer model 1210 is time independent (ie fixed), the print/scan model application step 225 will also be time independent, reflecting the time independent nature of the printer model 1210. Each sub-model in the process 810, 820, 830 is therefore as described in the primary embodiment, however the parameters of each of the processes 810, 820, 830 are fixed. For example, the dot-gain model 810 and MTF model 820 may use fixed values of d=0.2 and t=0.1. The colour model 830 may make the fixed assumption that plain white office paper is in use. In order to determine the level of unexpected differences (ie print defects), the alternate embodiment uses the printer operating conditions 840 as part of step 520, as shown in FIG. 13.

FIG. 13 shows the process of FIG. 6 as modified in the alternate embodiment. Unlike the step 630 of FIG. 6 which uses a constant value for D_{defect} to determine whether or not a pixel is defective, step 1310 of FIG. 13 updates the tile defect map using an adaptive threshold based on the printer operating conditions 840. In one implementation of the system, the value chosen for D_{defect} is as follows [30]:

D_{defect}=10+10(MAX(d_{c},dₘ,d_{y},dₖ))+Dₚₐₚₑᵣ [30]

Where d_{c}, dₘ, d_{y}, dₖ are the drum age factors for the cyan, magenta, yellow, and black drums respectively, and Dₚₐₚₑᵣ is a correction factor for the type of paper in use. This correction factor may be determined for a given sample paper type by measuring the Delta-E value between a standard white office paper and the sample paper type using, for example, a spectrophotometer.

### INDUSTRIAL APPLICABILITY

The arrangements described are applicable to the computer and data processing industries and particularly industries in which printing is an important element.

The foregoing describes only some embodiments of the present invention, and modifications and/or changes can be made thereto without departing from the scope and spirit of the invention, the embodiments being illustrative and not restrictive.

We claim:

1. A method for detecting print errors in an output of a printer, said method comprising the steps of:
receiving a scan image of an output print, said output print being produced by a print mechanism of the printer from a source document;
providing a set of parameters, said set of parameters modelling characteristics of the printer;
receiving operating condition data for at least a part of the printer;
determining a value associated with one or more parameters of the set of parameters based on the received operating condition data;
generating from the source document an expected digital representation of the output print, said expected digital representation being a render of the source document modified in accordance with the determined value associated with each of the one or more parameters and said expected digital representation compensating for output errors associated with operating conditions of the printer; and
comparing the generated expected digital representation to the received scan image of the output print in order to detect print errors in the output of the printer.

2. A method for detecting print errors, the method comprising:
printing a source input document to form an output print;
imaging the output print to form a scan image;
determining a set of parameters modelling characteristics of the printer used to perform the printing step;
determining values for the set of parameters dependent upon operating condition data for the printer;
rendering the source document, dependent upon the parameter values, to form an expected digital representation; and
comparing the expected digital representation to the scan image to detect the print errors.

3. A method for detecting print errors, the method comprising:
printing a source input document to form an output print;
imaging the output print to form a scan image;
determining, dependent upon operating condition data for the printer used to perform the printing step, values for a set of parameters modelling characteristics of the printer;
rendering the source document, dependent upon the parameter values, to form an expected digital representation; and
comparing the expected digital representation to the scan image to detect the print errors.

4. A method for detecting print errors in an output of a printer, said method comprising the steps of:
receiving a scan image of an output print, said output print being produced by a print mechanism of the printer from a source document;
providing a set of parameters and parameter values modelling characteristics of the print mechanism of the printer;
generating from the source document an expected digital representation of an output print, said expected digital representation being a render of the source document modified in accordance with the set of parameter values;
receiving operating condition data for at least a part of the printer;
determining a comparison threshold value based on the received operating condition data, said comparison threshold value compensating for output errors associated with operating conditions of the printer;
comparing, in accordance with the determined comparison threshold value, the generated expected digital representation to the received scan image of the output print in order to detect print errors in the output of the printer.

5. A method for detecting print errors, the method comprising:
printing a source input document to form an output print;
imaging the output print to form a scan image;
determining a set of parameters and parameter values modelling characteristics of the printer used to perform the printing step;
rendering the source document, dependent upon the parameter values, to form an expected digital representation; and
comparing, using a threshold dependent upon operating condition data for the printer, the expected digital representation to the scan image to detect the print errors.

6. The method of any one of claims 1 to 5, further comprising a step of sending instructions to the printer to reproduce the output print if one or more errors are detected.

7. The method of any one of claims 1 to 5, wherein the operating condition data is one or more of:
Drum age; and
Type of paper.

8. The method of any one of claims 1 to 5, wherein the operating condition data is one or more of:
Time since last print; and
Remaining toner level.

9. The method of any one of claims 1 to 5, wherein the operating condition data is one or more of
Notification of a self-calibration event; and
Environmental conditions including one or more of humidity and temperature.

10. The method of any one of claims 1 to 5, wherein the comparison step includes a step of spatially aligning the expected digital representation and the scan image.

11. The method of any one of claims 1 to 5, wherein the detection step is based on the minimum difference in a neighbourhood of pixels.

12. The method of any one of claims 1 to 5, wherein the set of parameters includes one or more of:
MTF blur;
Dot-gain; and
Colour transform.

13. A printer including a module for performing a method according to any one of claims 1 to 5.

14. A printing system comprising at least a printing mechanism,
an operating condition detector of the print mechanism for determining the operating conditions affecting the print mechanism;
a print checking unit adapted to receive from the print system the operating conditions detected by the operating condition detector,
wherein the operating conditions received by the print checking unit are used to detect errors in print output generated by the print mechanism.

15. The printing system of claim 14, wherein the operating condition detector is one or more of a toner level sensor, a paper type sensor, a temperature and a humidity sensor.

16. A printer comprising:
a print engine for printing a source input document to form an output print;
an image capture system for imaging the output print to form a scan image;
a memory for storing a program; and
a processor for executing the program, said program comprising:
code for determining a set of parameters modelling characteristics of the printer used to perform the printing step;
code for determining values for the set of parameters dependent upon operating condition data for the printer;
code for rendering the source document, dependent upon the parameter values, to form an expected digital representation; and
code for comparing the expected digital representation to the scan image to detect the print errors.

17. A computer readable non-transitory tangible storage medium having recorded thereon a computer program for directing a processor to execute a method for detecting print errors, the program comprising:
code for printing a source input document to form an output print;
code for imaging the output print to form a scan image;
code for determining a set of parameters modelling characteristics of the printer used to perform the printing step;
code for determining values for the set of parameters dependent upon operating condition data for the printer;
code for rendering the source document, dependent upon the parameter values, to form an expected digital representation; and
code for comparing the expected digital representation to the scan image to detect the print errors.

18. A computer readable non-transitory tangible storage medium having recorded thereon a computer program for directing a processor to execute a method for detecting print errors, the program comprising:
code for printing a source input document to form an output print;
code for imaging the output print to form a scan image;
code for determining, dependent upon operating condition data for the printer used to perform the printing step, values for a set of parameters modelling characteristics of the printer;
code for rendering the source document, dependent upon the parameter values, to form an expected digital representation; and
code for comparing the expected digital representation to the scan image to is detect the print errors.
